(19) United States
(12) Patent Application Publication
(10) Pub. No.: US 2009/0222336 A1
(43) Pub. Date: Sep. 3, 2009

(54) TARGETED ADVERTISING METHOD FOR VENUE SEATING

(75) Inventors: Richard Allen Etheridge, JR., Statesville, NC (US); Darnell Laron Colbert, Charlotte, NC (US); Tony Curtis Scott, Concord, NC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: CONCEPT FUNNEL GROUP, LLC, Statesville, NC (US)

(21) Appl. No.: 12/040,945

(22) Filed: Mar. 3, 2008

(51) Int. Cl. G06Q 30/00

(52) U.S. Cl. 705/14

(57) ABSTRACT

The present invention provides a method for providing targeted advertising to individuals in a venue. Advertising content is delivered to a predetermined individual via a user interface associated with that individual's seat. The advertising content can be selected based on the location of the user interface. The advertising content can be selected based on stored demographic information associated with the individual's seat or related directly to the individual. The advertising content is conveyed to the individual at a predetermined condition associated with the event, such as a time out.

### BACKGROUND OF THE INVENTION

This invention relates generally to distributing media content to individuals at an event and more particularly to distributing advertisements to individuals within venues.

Spectator events and, in particular, spectator sporting events have become a multibillion dollar a year business throughout the world. Millions of people attend their favorite sporting events, choosing among baseball, soccer, basketball, hockey, football, tennis, golf, auto racing, horse racing, boxing, and many others. Rather than merely watching sporting events on television, fans are willing to pay for the privilege of attending such events live in order to enjoy the spontaneity and excitement.

It is known to provide advertising to fans at venues such as stadiums, arenas, concert halls and the like. Often the advertising presented at such a venue is in the form of posters, fixed signs, and video displayed on monitors or screens visible to a large portion of the audience at one time. By necessity, all of these forms of advertising are directed to a broad audience and in some cases, the content of an advertisement selected based on the general characteristics, i.e., demographics, of the audience to which it is directed. In large venues, the type of event, or identity of a specific performer can often be used as a major demographic identifier and advertising content can be selected accordingly. For example, advertisements at a sporting event can be of the type generally presented to fans of that sport.

A problem with this method of determining the particular advertising content is that it is likely that some members of the audience will not be interested in the content or the way that it is presented. This is because there is variation within a large group of people in individual interests, likes, and ability to spend money on advertised product. Even though most of the viewers of the advertisement may share common interests because of there shared interest in the event, some will not. Further, some viewers of the advertisement may have no interest in the event all and could be present for a variety of other reasons and as a result, have very few interests in common with fans of the event.

### BRIEF SUMMARY OF THE INVENTION

Accordingly, there is a need to provide advertising content that is targeted to particular individuals within a venue.

Therefore it is an object of the present invention to provide a method for providing advertising content that is selected based on demographic information related to a specific advertising outlet such as a monitor in a particular location.

It is another object of the present invention to provide a method for displaying content on a particular interface that is specifically directed to an individual viewing that interface.

It is another object of the present invention to provide a method for exposing advertising content to individuals at events through an interactive visual interface.

It is another object of the invention to provide advertising content to individuals that are most likely to be receptive to that particular content.

It is another object of the invention to provide a system and method through which an individual can place orders to purchase products.

It is another object of the invention to provide a system and method through which an individual can provide demographic data through an interactive interface.

It is another object of the invention to provide a system and method through which advertising can be made to individuals at a time when the individual is most likely to be receptive to it.

It is another object of the invention to provide a system and method through which advertising can be presented before and after the events and during breaks that occur during the event, such as time outs, intermissions, lulls between competitors or events, and the like.

Therefore there is provided a method for delivering targeted advertising to a predetermined location. There is provided a central processor, an event status input device, and a user interface that are configured to support the following steps: a) identifying a target individual or physical location; b) relating the target individual or physical location to a particular display; c) selecting particular advertising content to be presented on the display based on demographic data, wherein the data can be related to the interface, directly to the individual, or a combination of both; d) selecting the time that the particular advertisement is to be presented; e) determining the selected time such that presentation of the advertisement can be coordinated with the flow of the event; f) presenting the particular advertisement; f)i) transmitting the advertisement from the main computer; f)ii) receiving the advertisement at the interface; f)iii) displaying the advertisement; g) prompting for customer input such as for a purchase or data collection h) receiving the customer input.

In accordance with one aspect of the invention, the physical location is determined by a seat number associated with a predetermined display device.

In accordance with another aspect of the invention, the interface is positioned on a first seat.

In accordance with another aspect of the invention, the interface is visible by a person sitting in a second seat.

In accordance with another aspect of the invention, the interface is visible by a person sitting in the first seat.

In accordance with another aspect of the invention, input can be provided through the interface by a person sitting in the second seat.

### BRIEF DESCRIPTION OF THE DRAWINGS

The subject matter that is regarded as the invention may be best understood by reference to the following description taken in conjunction with the accompanying drawing figures in which:

FIG. 1 is a perspective view of user interfaces and associated individual viewers according to one embodiment of the present invention.

FIG. 2 is a schematic view of a system for targeted advertising according the embodiment of FIG. 1;

FIG. 3 is an interface database according to one embodiment of the invention;

FIG. 4 is a viewer database according to one embodiment of invention; and

FIG. 5 is a content database according to one embodiment of the invention.

### DETAILED DESCRIPTION OF THE INVENTION

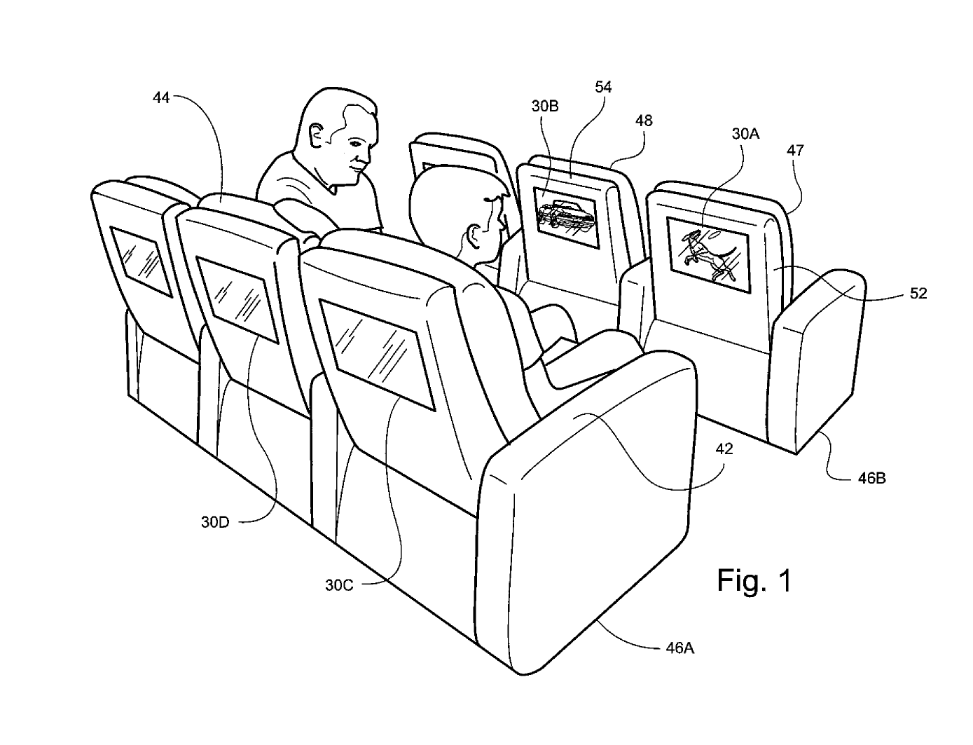

Referring to the drawings wherein identical reference numerals denote the same elements throughout the various views, FIG. 1 schematically illustrates system 10 for providing targeted advertising to individuals in a venue such as a sports arena or an auditorium.

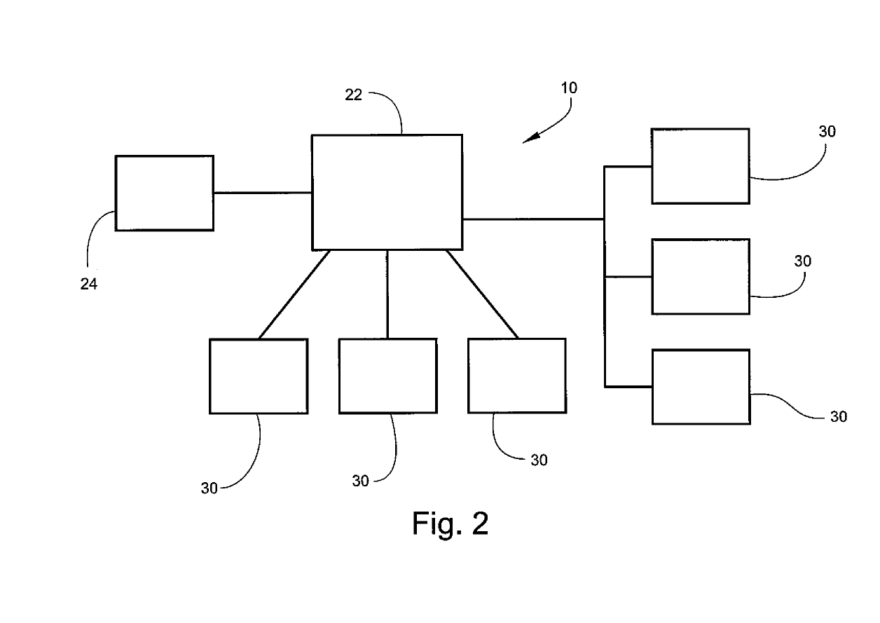

As shown in FIGS. 1 and 2, according to one embodiment of the invention, the system includes a central processor 22, multiple interfaces 30, and a group 32 of the interfaces 30. An event status input device 24 is provided for communicating event status information, such as the progression of the event, to the central processor 22. As used herein, the term “progression of the event” refers to the transition of the event taking place in the venue from one stage, such as active play, to another, such as a time out. In the illustrated embodiment, the input device 24 is a standard QWERTY keyboard, It should be appreciated that input device 24 can be any device for inputting data to the central processor 22 such as a cell phone, personal digital assistant, a numeric keypad, touch screen, voice recognition system, or the like.

In a preferred embodiment, each interface 30 is identified with an electronic address, such as an internet protocol (IP) address [please confirm] and includes structure for sending and receiving signals for communication with other electronic devices such as central processor 22 via electromagnetic waves.

Alternatively, each interface 30 could be electrically connected to the central processor 22 by a physical connector such as a metallic conductor or optic fiber conductor. Each interface is configured to communicate with the central processor 22 using electromagnetic waves transmitted over the physical conductor. It should be appreciated that each interface 30 could communicate with the central processor directly, or alternatively, via the internet according to known protocols.

In the illustrated embodiment, the interfaces 30 are configured to deliver both audio and visual information. Interfaces 30 are configured to receive input via touch screens and to send that input via electronic signal to the central processor.

The interfaces 30 are positioned within a venue at various locations. Each interface 30 is associated with a particular seat. For example, FIG. 2 shows a first interface 30A and a second interface 30B. For advertising and identification purposes, the first interface is associated with first seat 42 and the second interface 30B is associated with the second seat 44 that are both positioned such that the associated interface is physically accessible and visible therefrom.

The first seat 42 and the second seat 44 are positioned in a row 46A of seats which is behind another row 46B of seats. A third seat 47 and a fourth seat 48 are positioned in the row of seats 46B. The first interface 30A is positioned on a seatback 52 of third seat 47 and the second interface is positioned on a seatback 54 of the fourth seat 48. A third and fourth interface 30C and 30D are positioned on the first seat 42 and the second seat 44 in the same manner. Each of first seat 42, second seat 44, third seat 47, and fourth seat 48 are associated with a seat identifier, i.e., a seat number. Each seat could be further identified. For example, with regard to a level or a section within the venue.

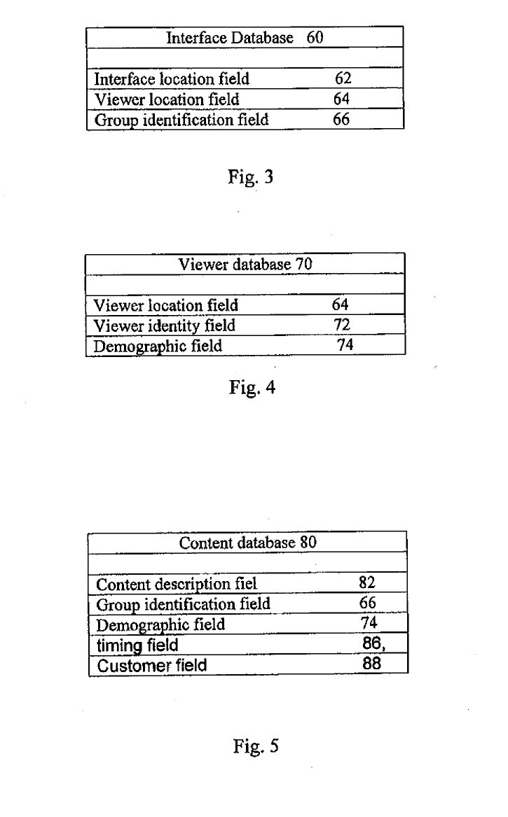

Referring now FIGS. 3, 4, and 5, the central processor 22 is configured to access and manipulate databases stored on a storage device or media for storing databases. The illustrated embodiment of the present invention includes an interface database 60, a viewer database 70, and a content database 80. The databases provide for the organization of information to be used in determining content to be sent to a user interface 30 and at what time during the event.

The interface database 60 includes the following fields: an interface location field 62, a viewer location field 64, and a group identification field 66. The interface location field 62 can include data indicative of the physical location of the first interface 30 which could, for example, be the seat number of the third seat 47. The viewer location field 64 can include data indicative of the viewer location of associated with the first seat 42 which could, for example, include data indicative of the seat number of the first seat 42 which is positioned behind third seat47. The group identification field 66 can include data indicative of a group of interfaces with which the first interface 30 is associated.

The viewer database 70, includes the following fields: the viewer location field 64, a viewer identity field 72, and at least one demographic field 74. The viewer location field 64 can include data indicative of the location of the viewer such as a seat number associated with the first seat 42. The viewer identity field 72 can include data indicative of the identity of the viewer. For example, the viewer identity field 72 can include the name of the viewer. The demographic field 74 can include demographic information such as the current event, age of viewer, or the like.

The viewer identity field can be entered by the viewer after being prompted by the associated interface or the viewer identity field can be completed using information obtained during the purchase of a ticket for that seat at that event. It is anticipated that such ticket purchase record information would be used in situations where demographic information was collected when the ticket purchase was made. This could be done for individual ticket sales or season ticket sales.

The content database 80 includes the following that are associated with particular advertising content: a content description field 82, a group identification field 66, a demographic field 74, a timing field 86, and a customer field 88. The content description field 82 can contain data indicative of the identity of the advertisement. The group field 84 can include data indicative of a predetermined group 32 of interfaces 30 to receive the advertisement. The demographic field 74 can include data indicative of predetermined information that must be associated with a viewer in order to receive the advertising content. The timing field 86 can contain data indicative of when the advertisement should be shown, e.g. at the beginning of the first time out. The customer field 88 can contain data indicative of the entity or person who requested and or provided the advertising content. The advertising content can be audio or video or a combination. The video can include still images such as photographs or moving images such as replays of the current event.

In some embodiments, the databases described above along with any additional databases associated with a particular embodiment can have more or less fields that those indicated above, can be combined, or can be otherwise configured as would be understood by one skilled in the art. The databases can be used as to select advertising content that is delivered to the first user interface 30 and to determine when the content will be delivered.

The present invention provides a method for providing targeted advertising to individuals in a venue. Advertising content is delivered to a predetermined individual via a user interface associated with that individual's seat. The advertising content can be selected based on the location of the user interface. The advertising content can be selected based on stored demographic information associated with the individual's seat or related directly to the individual. The advertising content is conveyed to the individual at a predetermined condition associated with the event, i.e., status, such as a time out.

More specifically, the present invention provides a method for providing targeted advertising to a predetermined individual in a venue that includes the following steps. First the content to be transmitted is selected by the central processor by correlating like fields in the interface database 60, the viewer database 70, and the content database 80. For example, if it is desired to present identical content to all individuals sitting in a predetermined group of seats, then the group identification field 66 in the content database 80 is set to the desired value, or group number. The central processor then identifies uses the user interface database 60 to identify all user interfaces in which the group identification field 66 contains the desired group number. The central processor is configured to deliver the advertising content to the selected user interfaces 30 when the event status corresponds to the value of the timing field 86 in the content database 80. In other words, the central processor is configured to deliver the advertising content at a particular time during the event, such as at the first timeout in the quarter.

In another example, the user interface 30 to receive particular advertising content is determined according to the demographic field 74 in the content database 80. The central processor obtains the value of the demographic field 74 in the content database 80. The central processor then identifies all records in the viewer identity data base 70 where the desired value is present in the appropriate demographic field 74. The advertising content is then delivered at the appropriate time to the user interfaces where the viewer location field 64 in the interface database 60j matches the viewer location field 64 in the selected viewer database 70.

In an alternative embodiment, multiple systems 10 are provided within one venue. In this regard, each system 10 could be directed to different areas of the venue such as upper and lower levels.

In an alternative embodiment, the central processor 10 is located at a location that is geographically remote from the venue and is accessed either by direct electronic communication or by distributed electronic communication such as that that occurs over the internet.

In an alternative embodiment, the central processor 10 is a multiple of independent processing units such as multiple personal computers. In this embodiment, each of the independent processing units can be located geographically remote from the others.

In an alternative embodiment, each interface is associated with the seat to which it is mounted for advertising purposes. In this embodiment, the interface could be mounted to the seat via an arm or boom configured to position the interface in front of the individual in the associated seat.

The present invention provides a method for providing targeted advertising to individuals associated with venue seating. The manner in which the targeted advertising method is performed is described in more detail after a description of the system hard ware is provided.

To summarize, in one embodiment, the present invention provides a method of providing targeted advertising content to individuals at an event based on their seat location. In this regard each seat is associated with a user interface that is configured for two way communication with a central processor. The central processor is configured to communicate advertising content to the user interface and to select the advertising content based on the location of the individual's seat. The content is delivered at optimum times for obtaining viewer attention, such as during time outs. The central processor is configured to maintain databases for use in selecting advertising content to be delivered to a user interface. The selection can be based on demographic data associated with a particular seat or the selection can be based on demographic data associated with a group of seats. In this regard, the seat locations in a venue could be divided into multiple groups that each represent different ticket price levels. Advertising content is selected for each group based on the amount of disposable income that an individual that can purchase tickets in that group is determined to have.

The foregoing has described a system for directing advertising to individuals at a venue. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A method for providing targeted advertising to individuals in a venue, the method comprising the steps of:
a) providing a central processor, a user interface configured to receive content from the central processor and convey the content to a predetermined individual, an input device configured to transmit event status information to the central processor, wherein the central processor is configured to select content and initiate transmission of selected content to the user interface;
b) select content to be transmitted;
c) identifying the predetermined individual based on the location of the predetermined individuals seat;
d) monitoring event status for predetermined condition;
e) determining existence of predetermined condition;
f) initiating transmission of selected content; and
g) conveying selected content to predetermined individual through the user interface, wherein in the user interface is associated with the predetermined individuals location.

2. The targeted advertising method according to claim 1, further comprising the step of:
h) prompting for input by the predetermined individual at the user interface.

3. The targeted advertising method according to claim 1, further comprising the steps of:
i) receiving the input by the predetermined individual at the user interface; and
j) transmitting the input by the predetermined individual from the user interface to the central processor.

4. The targeted advertising method according to claim 3, wherein the input by the predetermined individual is an order to purchase.

5. The targeted advertising method according to claim 3, wherein the input by the predetermined individual includes demographic data related to the individual.

6. The targeted advertising method according to claim 5, wherein the demographic data specifically identifies the predetermined viewer.

7. The targeted advertising method according to claim 5, further comprising the steps of:
a) transmitting the demographic data to the central processor; and
b) storing the demographic data.

8. The targeted advertising method according to claim 1, wherein the predetermined condition is a time out.

9. A method for providing targeted advertising to individuals in a venue, the method comprising the steps of:
a) providing a central processor, a user interface configured to receive content from the central processor and convey the content to a predetermined individual, an input device configured to transmit event status information to the central processor, wherein the central processor is configured to select content and initiate transmission of selected content to the user interface, and providing a first user interface that is associated with a first seat and a second user interface that this associated with a second seat;
b) selecting first content to be transmitted to the first user interface based on the location of the first seat;
c) selecting second content to be transmitted to the second interface based on the location of the second seat;
d) monitoring event status to detect a predetermined condition;
e) detecting the predetermined condition;
f) initiating transmission of selected first content and selected second content;
g) conveying the selected first content to the first user interface; and
h) conveying the selected second content to the second user interface.

10. A method for providing targeted advertising according to claim 1, further comprising the step of determining a viewer identity associated with a viewer that is sitting in the first seat.

11. A method for providing targeted advertising according to claim 10, wherein said step of determining the viewer identity further comprises the steps of:
a) prompting the viewer to enter an identification sequence by displaying a prompt message on the interface;
b) displaying the prompt message on the interface for a predetermined period of time;
c) removing the prompt from the interface after one of the following occurs:
i) a predetermined time period for entering the identification sequence expires
ii) the viewer enters an identification sequence

12. A method for providing targeted advertising according to claim 9, wherein the first seat is part of a first group of multiple seats and the second seat is part of a second group of multiple seats.

13. A method for providing targeted advertising according to claim 12, wherein the first content is selected based on the first group and the second content is based on the second group.
